(19) United States
(12) Patent Application Publication
(10) Pub. No.: US 2019/0299370 A1
(43) Pub. Date: Oct. 3, 2019

(54) BATHTUB AND SINK DRAIN REMOVAL TOOL

(71) Applicant: Brent Thompson, Greenfield, IN (US)

(72) Inventor: Brent Thompson, Greenfield, IN (US)

(21) Appl. No.: 15/942,493

(22) Filed: Mar. 31, 2018

(51) Int. Cl. B25B 13/48; B25G 1/10

(52) U.S. Cl. CPC B25B 13/48; B25B 23/12; B25G 1/102

(57) ABSTRACT

A tool to remove a drain having a plurality rails that form a plurality of holes, the tool including a body having a predetermined length, a plurality of protrusions disposed at a first end of the body to fit into the holes of the drain, and a plurality of notches formed between the plurality of protrusions to each receive one of the plurality of rails of the drain, such that rotating the tool provides an equal amount of pressure on side portions of the plurality of rails of the drain.

### BACKGROUND

### 1. Field

The present general inventive concept relates generally to a tool, and particularly, to a tool to facilitate removal of a bathtub and/or sink drain.

### 2. Description of the Related Art

When overhauling a bathroom, there are certainly complications, as with any home improvement project. For some, removing a drain of a bathtub, or even a sink, can be a difficult and complicated process.

Therefore, there is a need for a device that allows a user to easily remove a drain of a bathtub.

### SUMMARY

The present general inventive concept provides a tool to facilitate removal of a bathtub and/or sink drain.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing a tool to remove a drain having a plurality rails that form a plurality of holes, the tool including a body having a predetermined length, a plurality of protrusions disposed at a first end of the body to fit into the holes of the drain, and a plurality of notches formed between the plurality of protrusions to each receive one of the plurality of rails of the drain, such that rotating the tool provides an equal amount of pressure on side portions of the plurality of rails of the drain.

The tool may further include a handle disposed at a second end of the body to provide a grip for a user.

The plurality of protrusions may be provided as a set of four protrusions, and the plurality of notches are provided as a set of four notches.

### BRIEF DESCRIPTION OF THE DRAWINGS

These and/or other features and utilities of the present generally inventive concept will become apparent and more readily appreciated from the following description of the embodiments, taken in conjunction with the accompanying drawings of which:

FIG. 1 illustrates a side view of a tool to remove a drain, according to an exemplary embodiment of the present general inventive concept; and

FIG. 2 illustrates a top angled view of the tool to remove the drain, according to an exemplary embodiment of the present general inventive concept.

### DETAILED DESCRIPTION

Various example embodiments (a.k.a., exemplary embodiments) will now be described more fully with reference to the accompanying drawings in which some example embodiments are illustrated. In the figures, the thicknesses of lines, layers and/or regions may be exaggerated for clarity.

Accordingly, while example embodiments are capable of various modifications and alternative forms, embodiments thereof are shown by way of example in the figures and will herein be described in detail. It should be understood, however, that there is no intent to limit example embodiments to the particular forms disclosed, but on the contrary, example embodiments are to cover all modifications, equivalents, and alternatives falling within the scope of the disclosure. Like numbers refer to like/similar elements throughout the detailed description.

It is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.

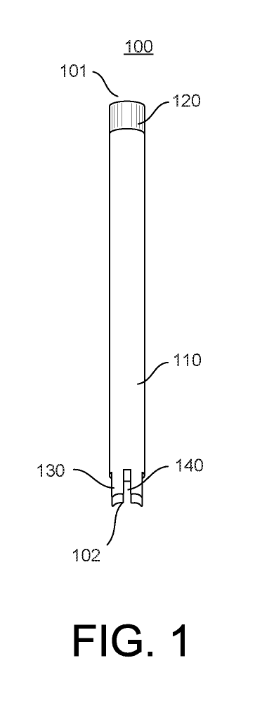

FIG. 1 illustrates a side view of a tool 100 to remove a drain 10, according to an exemplary embodiment of the present general inventive concept.

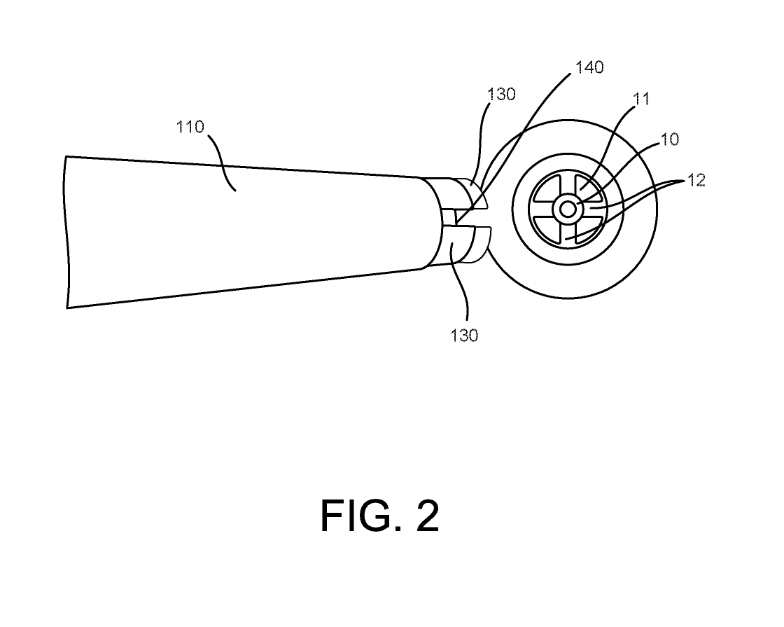

FIG. 2 illustrates a top angled view of the tool 100 to remove the drain 10, according to an exemplary embodiment of the present general inventive concept.

The drain 10 may be made from metal or plastics, and may include a plurality of rails 12 disposed in a cross formation (i.e., a “plus” and or addition sign), such that the plurality of rails 12 form a plurality of holes 11.

The tool 100, and components thereof, may be constructed from metal, wood, plastic, rubber, or any other material known to one of ordinary skill in the art.

The tool 100 may include a body 110, a handle 120, a plurality of protrusions 130, and a plurality of notches 140.

The body 110 may have a predetermined length to allow a user to generate ample torque.

Also, the body 110 may have a circular shape when views from a top portion thereof, as illustrated in FIG. 2.

Furthermore, the body 110 may have a predetermined thickness (i.e., diameter) in order to properly fit a bottom end portion thereof into a bathtub and/or sink drain.

Finally, the body 110 may have a length between 6 inches and 36 inches, in order to allow a user to easily utilize the tool 100.

The handle 120 may be disposed at a first end 101 of the tool 100 (i.e., a top end), and may be utilized at a grip by a user.

The plurality of protrusions 130 may be provided as four protrusions (but are not limited thereto) at a second end 102 of the tool 100, in order to appropriately fit into most universally constructed drains.

The plurality of notches 140 may also be provided as four protrusions (but are not limited thereto) at the second end 102 of the tool 100, in order to appropriately fit into most universally constructed drains.

The plurality of notches 140 may be formed between the plurality of protrusions 130. More specifically, two adjacent protrusions of the plurality of protrusions 130 form one of the plurality of notches 140. As such, if there are four protrusions 130, then there would be four notches 140.

More specifically, referring to FIGS. 1 and 2, it is clear that the plurality of protrusions 130 may each be inserted into the plurality of holes 11 of the drain 10, such that the plurality of notches 140 may each receive one of the plurality of rails 12 of the drain 10. As a result, when the second end 102 of the tool 100 is fully inserted within the drain 10, the tool 100 may be rotated counter-clockwise such that the plurality of protrusions may apply an equal amount of pressure to side portions of the rails 12, thereby allowing a user to unscrew and remove the drain 10.

Alternatively, the user may rotate the tool 100 in a clockwise direction to install the drain 10.

As such, the handle 120 may be constructed from a material, such as rubber, to allow the user to maintain a firm grip on the tool 100 during removal of the drain 10. Also, various portions of the body 110 and/or the handle 120 may have shapes other than circular, such as square, hexagonal, etc., in order to facilitate the user's grip on the tool 100.

Additionally, the second end 102 may be magnetized in order to allow the drain 10 to stick to the second end 102 after the drain 10 is unscrewed, to promote easy and convenient removal of the drain 10.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A tool to remove a drain having a plurality rails that form a plurality of holes, the tool comprising:
a body having a predetermined length;
a plurality of protrusions disposed at a first end of the body to fit into the holes of the drain; and
a plurality of notches formed between the plurality of protrusions to each receive one of the plurality of rails of the drain, such that rotating the tool provides an equal amount of pressure on side portions of the plurality of rails of the drain.

2. The tool of claim 1, further comprising:
a handle disposed at a second end of the body to provide a grip for a user.

3. The tool of claim 1, wherein the plurality of protrusions are provided as a set of four protrusions, and the plurality of notches are provided as a set of four notches.
